(19) United States
(12) Patent Application Publication
(10) Pub. No.: US 2012/0249849 A1
(43) Pub. Date: Oct. 4, 2012

(54) IMAGE PICKUP DEVICE

(75) Inventors: Yoichi NAKANO, Chiba (JP); Chiaki Nemoto, Chiba (JP)

(73) Assignee: SEIKO PRECISION INC., Narashino-shi (JP)

(21) Appl. No.: 13/430,888

(22) Filed: Mar. 27, 2012

(30) Foreign Application Priority Data
Mar. 29, 2011 (JP) 2011-073267

(51) Int. Cl. H04N 5/335

(52) U.S. Cl. 348/296; 348/E05.091

(57) ABSTRACT

An image pickup device includes: an image pickup element; a control portion sequentially resetting charge stored in the image pickup element for every pixel line in a predetermined direction such that an electronic leading shutter moves in a simulated manner; a focal plane shutter including: a board including an opening; a mechanical type of a trailing shutter capable of opening and closing the opening; an actuator driving the trailing shutter; and a detection portion detecting that the trailing shutter passes through a given position of a movement trace of the trailing shutter; and a drive control portion controlling driving of the actuator based on a detection result of the detection portion.

### CROSS-REFERENCE TO RELATED APPLICATION

This application is a continuation of and claims priority to Japanese Patent Application No. 2011-073267 filed on Mar. 29, 2011, subject matter of these patent documents is incorporated by reference herein in its entirety.

### BACKGROUND

(i) Technical Field

The present invention relates to image pickup devices.

(ii) Related Art

Japanese Patent Application Publication No. 2010-245604 discloses an image pickup device that controls an electronic leading shutter on the basis of moving characteristics of a mechanical trailing shutter.

However, in the image pickup devices employing such an electronic leading shutter, there is no image pickup device controlling the drive of the mechanical trailing shutter.

### SUMMARY

It is therefore an object of the present invention to provide an image pickup device that employs an electronic leading shutter and controls the drive of a mechanical trailing shutter.

According to an aspect of the present invention, there is provided an image pickup device including: an image pickup element; a control portion sequentially resetting charge stored in the image pickup element for every pixel line in a predetermined direction such that an electronic leading shutter moves in a simulated manner; a focal plane shutter including: a board including an opening; a mechanical type of a trailing shutter capable of opening and closing the opening; an actuator driving the trailing shutter; and a detection portion detecting that the trailing shutter passes through a given position of a movement trace of the trailing shutter; and a drive control portion controlling driving of the actuator based on a detection result of the detection portion.

### BRIEF DESCRIPTION OF THE DRAWINGS

FIG. 1 is a block view of a camera including a focal plane shutter;

FIG. 2 is a front view of the focal plane shutter;

FIGS. 3A and 3B are explanatory views of a leading shutter actuator and a trailing shutter actuator, respectively;

FIG. 4 is an explanatory view of a thin plate;

FIGS. 5A and 5B are explanatory views of a sensor;

FIG. 6 is a timing chart of the focal plane shutter;

FIG. 7 is an explanatory view of the operation of the focal plane shutter;

FIG. 8 is an explanatory view of the operation of the focal plane shutter;

FIG. 9 is an explanatory view of the operation of the focal plane shutter;

FIG. 10 is an explanatory view of the operation of the focal plane shutter;

FIG. 11 is an explanatory view of the operation of the focal plane shutter;

FIG. 12 is a timing chart in a case where a moving speed of the trailing shutter is reduced;

FIG. 13 is a timing chart when an electric current applied to a trailing shutter coil is changed;

FIGS. 14A and 14B are maps for correcting a value of a current applied to the trailing shutter coil; and

FIGS. 15A to 15F are explanatory views of variations of a value of a current applied to the trailing shutter coil while the trailing shutter is moving.

### DETAILED DESCRIPTION

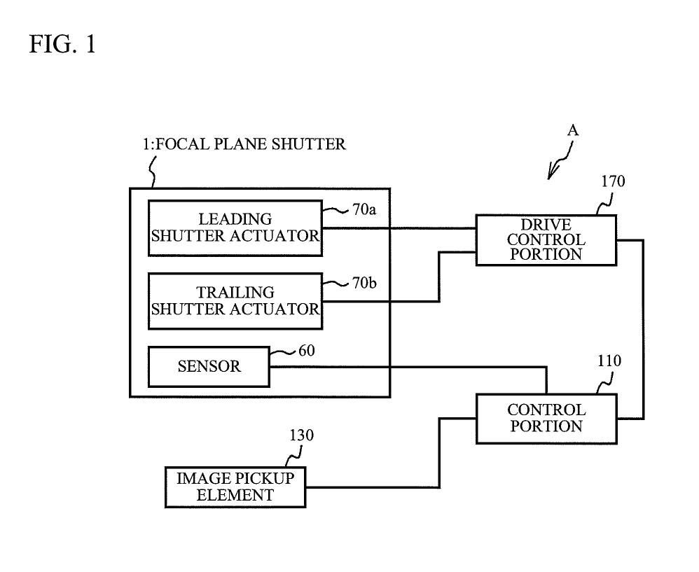

FIG. 1 is a block view of a camera (image pickup device) A including a focal plane shutter 1. The camera A includes the focal plane shutter 1, a control portion 110, an image pickup element 130, and a drive control portion 170. The focal plane shutter 1 includes a leading shutter actuator 70a, a trailing shutter actuator 70b, and a sensor 60, as will be described later in detail. The drive control portion 170 controls the drive of the leading shutter actuator 70a and the trailing shutter actuator 70b in accordance with the instruction from the control portion 110. The drive control portion 170 includes a CPU. The control portion 110 instructs the drive control portion 170 in accordance with the signals from the sensor 60, as will described later in detail. In response to this instruction, the drive control portion 170 controls the drive of the leading shutter actuator 70a and the trailing shutter actuator 70b. The control portion 110 controls the operation of the whole camera, and includes the CPU, a ROM, and a RAM. The image pickup element 130 is a CMOS. The image pickup element 130 is a light receiving element which converts subject images into electric signals on the basis of photoelectric conversion.

The control portion 110 is an example of a control portion sequentially resetting charge stored in the image pickup element 130 for every pixel line in a predetermined direction such that an electronic leading shutter moves in a simulated manner. Specifically, the charge stored in the image pickup element 130 are reset for every pixel line in a direction perpendicular to the movement direction of a leading shutter 20A and a trailing shutter 20B, described later. Therefore, the electronic leading shutter moves from an exposure start position to an exposure terminal position in a simulated manner. Moreover, the camera A includes lenses, not illustrated in FIG. 1, for adjusting a focal length.

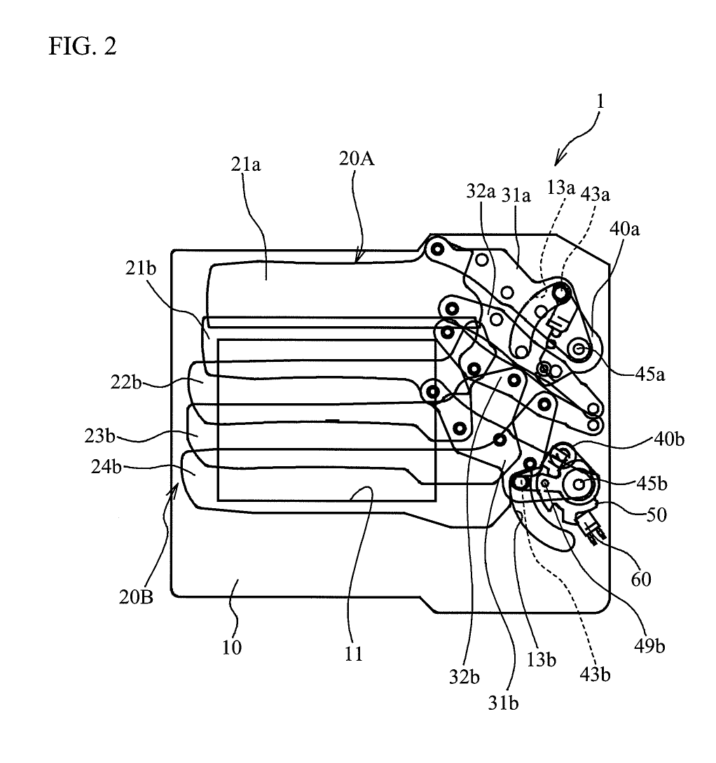

FIG. 2 is a front view of the focal plane shutter 1. In FIG. 2, the leading shutter actuator 70a, the trailing shutter actuator 70b are omitted. The focal plane shutter 1 includes a board 10, blades 21a, and 21b to 24b, arms 31a, 32a, 31b, and 32b, the leading shutter actuator 70a, and the trailing shutter actuator 70b. The board 10 is provided with a rectangular opening 11.

The trailing shutter 20B includes four blades 21b to 24b. Also, the leading shutter 20A includes four blades, however, only one blade 21a is illustrated in FIG. 2. Both of the leading shutter 20A and the trailing shutter 20B are mechanical ones. FIG. 2 illustrates the leading shutter 20A in an overlapped state and the trailing shutter 20B in an expanded state. In FIG. 2, the leading shutter 20A recedes from the opening 11, and the trailing shutter 20B closes the opening 11.

The leading shutter 20A are connected to the arms 31a and 32a. The trailing shutter 20B are connected to the arms 31b and 32b. These arms 31a, 32a, 31b, and 32b are rotatably supported by the board 10.

The board 10 is provided with a leading shutter drive lever 40a and a trailing shutter drive lever 40b that drive the arms 31a and 31b, respectively. The leading shutter drive lever 40a and the trailing shutter drive lever 40b are respectively provided with spindles 45a and 45b. The spindles 45a and 45b are rotatably supported by the board 10. Thus, each of the leading shutter drive lever 40a and the trailing shutter drive lever 40b is rotatably supported in a given range by the board 10. The leading-blades drive lever 40a and the trailing-blades drive lever 40b are respectively provided with drive pins 43a and 43b. The board 10 is provided with escape holes 13a and 13b that escape the movements of the drive pins 43a and 43b, respectively. Each of the escape holes 13a and 13b has an arc shape. The drive pins 43a and 43b are respectively fitted into a fitting hole of the arm 31a and a fitting hole of the arm 31b. Rotating the leading shutter drive lever 40a causes the arm 31a to rotate and to move the leading shutter 20A. Likewise, rotating the trailing shutter drive lever 40b causes the arm 31b to rotate and to move the trailing shutter 20B. Additionally, the trailing shutter drive lever 40b is provided with a thin plate 50. The thin plate 50 rotates with the trailing shutter drive lever 40b. The sensor 60, as will be described later in detail, is arranged on the board 10.

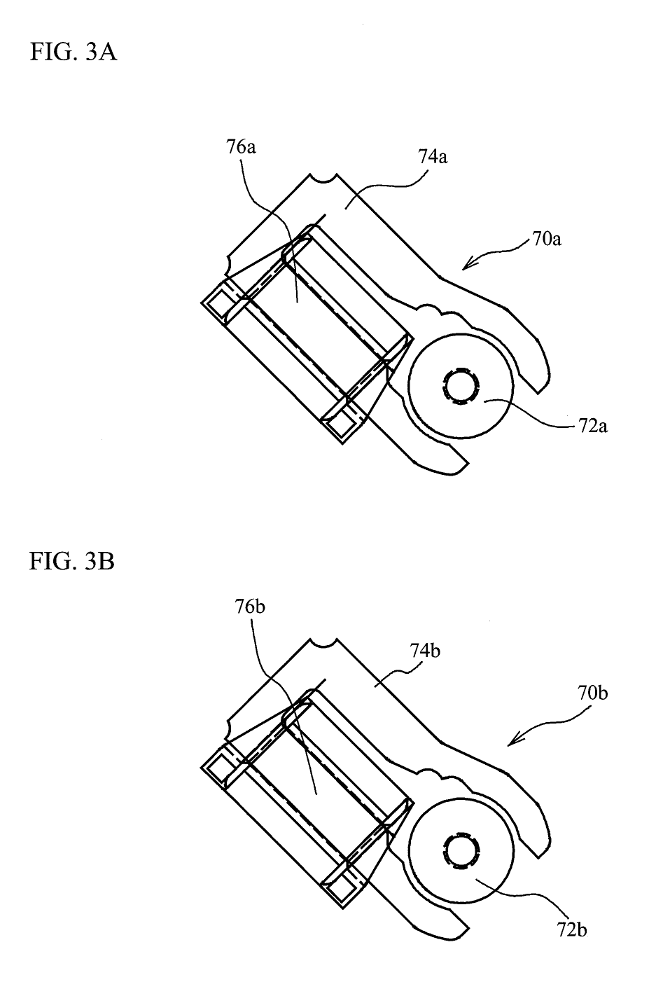

FIGS. 3A and 3B are explanatory views of the leading shutter actuator 70a and the trailing shutter actuator 70b respectively. The leading shutter actuator 70a and the trailing shutter actuator 70b are supported by the board 10. The leading shutter actuator 70a and the trailing shutter actuator 70b drive the leading shutter drive lever 40a and the trailing shutter drive lever 40b respectively. The leading shutter actuator 70a includes: a rotor 72a rotatably supported by the board 10; a stator 74a excited to generate a magnetic force between the stator 74a and the rotor 72a; and a leading shutter coil 76a for exciting the stator 74a. The rotor 72a is a permanent magnet which is magnetized to have different polarities in a circumferential direction. A rotational axis of the rotor 72a is connected to the spindle 45a of the leading shutter drive lever 40a. Thus, the energization of the leading shutter coil 76a rotates the rotor 72a, and then the leading shutter drive lever 40a rotates. The rotation of the leading shutter drive lever 40a moves the leading shutter 20A. Also, the reverse enegization of the leading shutter coil 76a reversely rotates the rotor 72a, and then the leading shutter 20A moves in the direction opposite to the above mentioned direction. Likewise, in the trailing shutter actuator 70b, the energization of a trailing shutter coil 76b rotates a rotor 72b of the trailing shutter actuator 70b so as to rotate the trailing drive lever 40b, and then the trailing shutter 20B moves. Also, the reverse energization of the trailing shutter coil 76b moves the trailing shutter 20B in the direction opposite to the above mentioned direction. Additionally, the rotor 72a and the leading shutter drive lever 40a may be indirectly connected to each other through a gear. That is, the leading shutter drive lever 40a has only to rotate in response to the rotation of the rotor 72a.

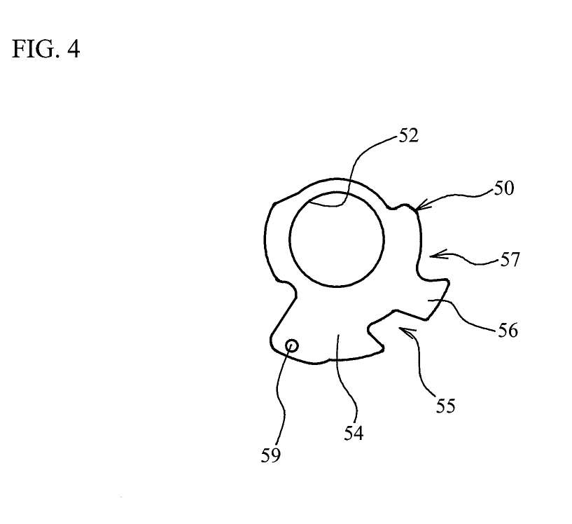

FIG. 4 is an explanatory view of the thin plate 50. The thin plate 50 has a thin plate shape. The thin plate 50 includes a fitting hole 52 into which the spindle 45b of the trailing shutter drive lever 40b is fitted. Also, the thin plate 50 is formed with an engagement hole 59 into which an engagement pin 49b of the trailing shutter drive lever 40b is fitted. The thin plate 50 is formed with a projection portion 54, a cutout portion 55, a projection portion 56, and a cutout portion 57 in a counterclockwise order about the fitting hole 52. The projection portions 54 and 56 protrude radially outward. The engagement hole 59 is formed at an edge of the projection portion 54.

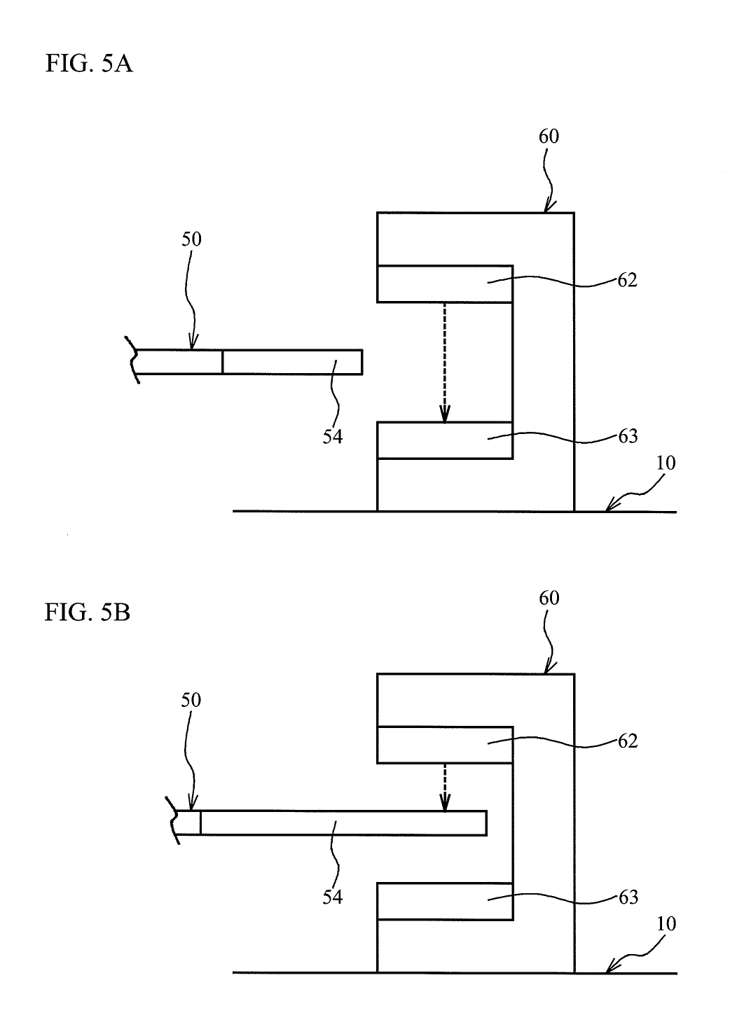

FIGS. 5A and 5B are explanatory views of the sensor 60. The sensor 60 is arranged on the board 10. The sensor 60 has a light emitting element 62 and a light receiving element 63 that are arranged to face each other. The light receiving element 63 receives the light emitted from the light emitting element 62. As illustrated in FIGS. 5A and 5B, the rotation of the trailing shutter drive lever 40b moves the projection portions 54 and 56 of the thin plate 50 in between the light emitting element 62 and the light receiving element 63. When the projection portions 54 and 56 of the thin plate 50 is located between the light emitting element 62 and the light receiving element 63, the light emitted from the light emitting element 62 is shaded. At this time, whether or not the thin plate 50 is positioned between the light emitting element 62 and the light receiving element 63 can be detected based on output signals from the light receiving element 63, thereby detecting the position of the trailing shutter drive lever 40b. This can result in detecting the position of the trailing shutter 20B.

Additionally, the sensor 60 is not limited to the above configuration. For example, the sensor 60 may include: a light emitting element; a mirror reflecting the light emitted from the light emitting element; and a light receiving element receiving the light reflected by the mirror. The thin plate 50 is positioned between the light emitting element and the mirror, or between the light receiving element and the mirror, thereby detecting the position of the thin plate 50.

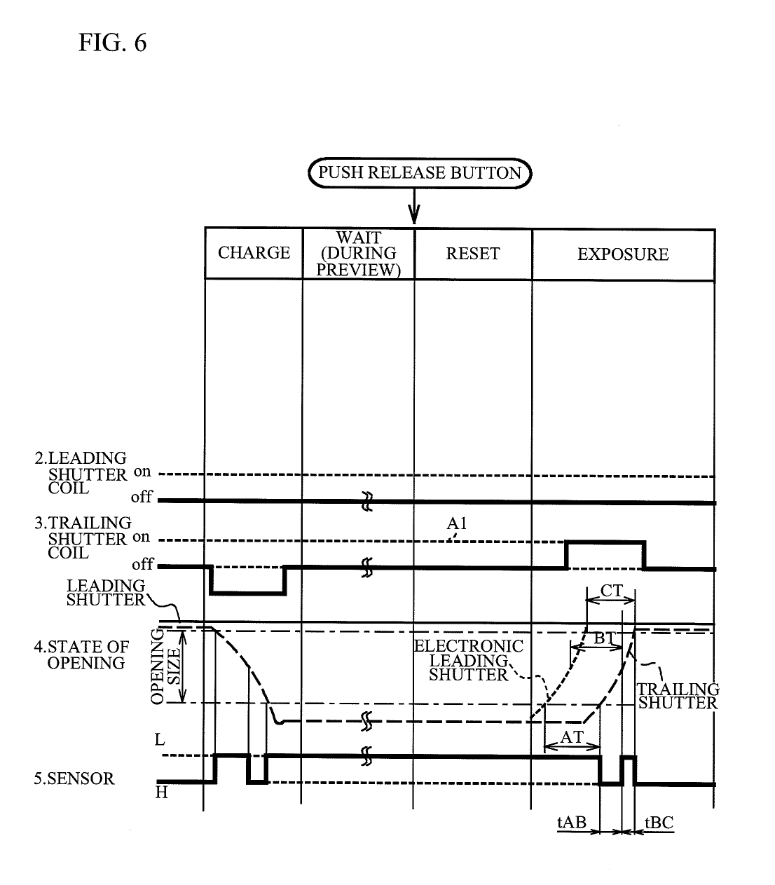

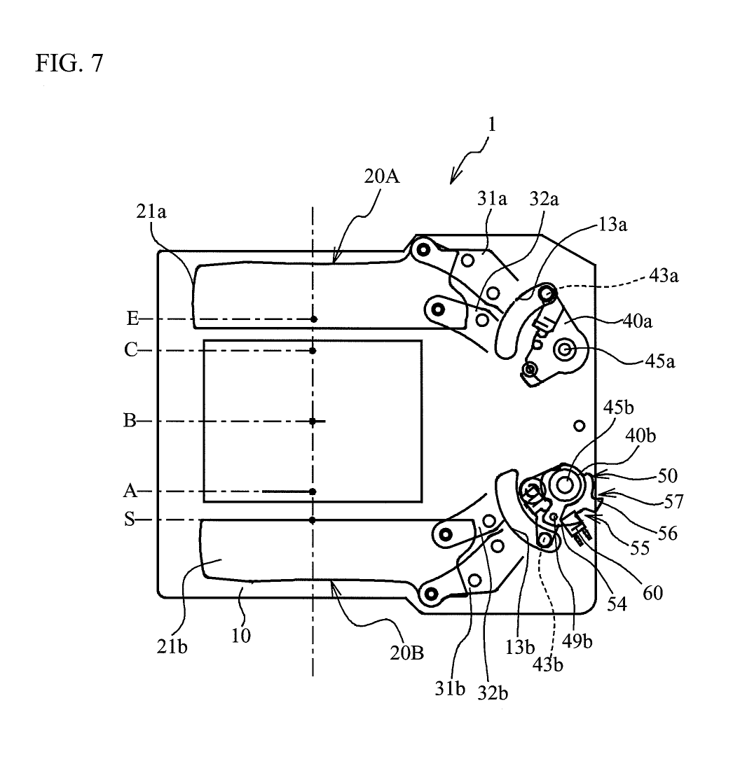

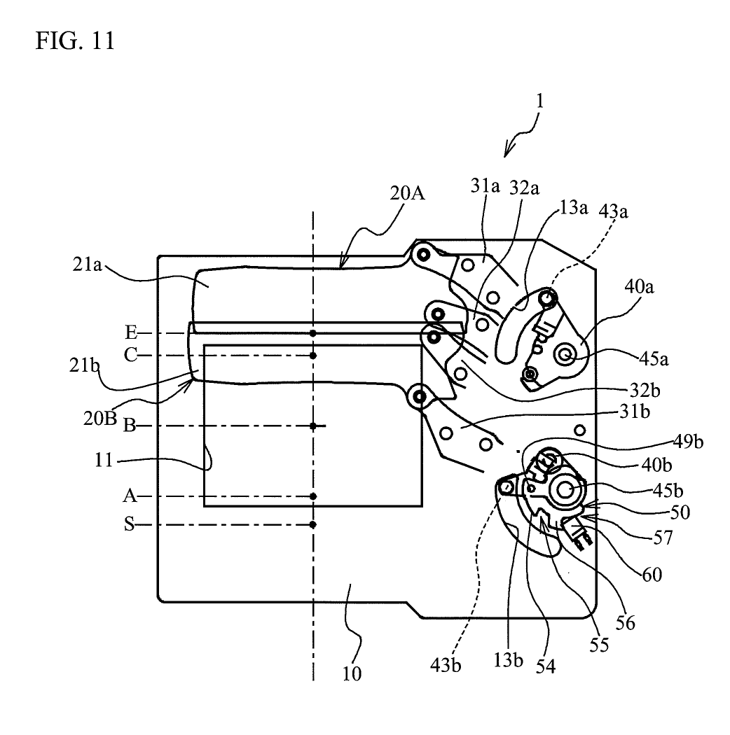

Next, an operation of the focal plane shutter 1 will be described. FIG. 6 is a timing chart of the focal plane shutter 1. FIGS. 7 to 11 are explanatory views of the operation of the focal plane shutter 1. Additionally, some parts are omitted in FIGS. 7 to 11. Also, FIGS. 7 to 11 illustrate the blades 21a and 21b. The blade 21b is one of the plural blades composing the trailing shutter 20B, and is connected at the position closest to the ends of the arms 31b and 32b. Also, the blade 21b advances the earliest in the blades of the trailing shutter 20B moving toward the opening 11. Additionally, FIG. 11 illustrates the exposure operation finished state.

In the exposure operation finished state in FIG. 11, the reverse energization of the trailing shutter coil 76b rotates the trailing shutter drive lever 40b counterclockwise. Thus, the trailing shutter 20B recedes from the opening 11 in the overlapped state as illustrated in FIG. 7. This causes the opening 11 to be in the fully opened state. Also, the counterclockwise rotation of the trailing shutter drive lever 40b rotates the thin plate 50 counterclockwise. The counterclockwise rotation of the thin plate 50 causes the cutout portion 57, the projection portion 56, the cutout portion 55, the projection portion 54, in this order, to pass between the light emitting element 62 and the light receiving element 63 of the sensor 60. The thin plate 50 stops with the projection portion 54 located between the light emitting element 62 and the light receiving element 63. Therefore, the light from the light emitting element 62 is shaded by the projection portion 54 of the thin plate 50. As mentioned above, in the charge state of charging before the exposure illustrated in FIG. 6, since the cutout portion 57, the projection portion 56, the cutout portion 55, the projection portion 54 pass between the light emitting element 62 and the light receiving element 63, output signals from the sensor 60 change. Specifically, the output signals from the sensor 60 illustrated in FIG. 6 are output signals from the light receiving element 63. When the light from the light emitting element 62 is shaded by the thin plate 50, the light receiving element 63 outputs an L signal to the control portion 110. When the light receiving element 63 receives the light from the light emitting element 62, the light receiving element 63 outputs an H signal to the control portion 110.

In a wait state, the opening 11 is maintained in a fully opened state. After that, a release button of the camera A is pushed at the time of taking a photo, providing an exposure state where the exposure is performed after a predetermined period is lapsed, through a reset state where the data of the image pickup element 130 are cleared. In the exposure state, the control portion 110 controls the image pickup element 130 to move the electronic leading shutter from the exposure start position to the exposure end position in a simulated manner. After the predetermined period is elapsed from the time when the electronic leading shutter starts moving, the control portion 110 instructs the drive control portion 170 to apply an electric current of the current value A1 to the trailing shutter coil 76b. Here, the current value A1 is a value set at the time of shipment of the camera A according to the present embodiment. The application of the electric current to the trailing shutter coil 76b rotates the rotor 72b clockwise. Therefore, the trailing shutter 20B starts moving to the opening 11. Thus, as for the blade 21b, the trailing shutter 20B closes the opening 11 as illustrated in FIGS. 7 to 11.

FIG. 7 illustrates three points A to C on the trace of the movement of the trailing shutter 20B. The points A to C indicate passage positions of the trailing shutter 20B which the sensor 60 can detect. Further, FIG. 7 illustrates a start point S indicating a position of a leading edge of the blade 21b when the blade 21b starts moving, and a stop point E indicating a position of the leading edge of the blade 21b when the blade 21b finishes moving.

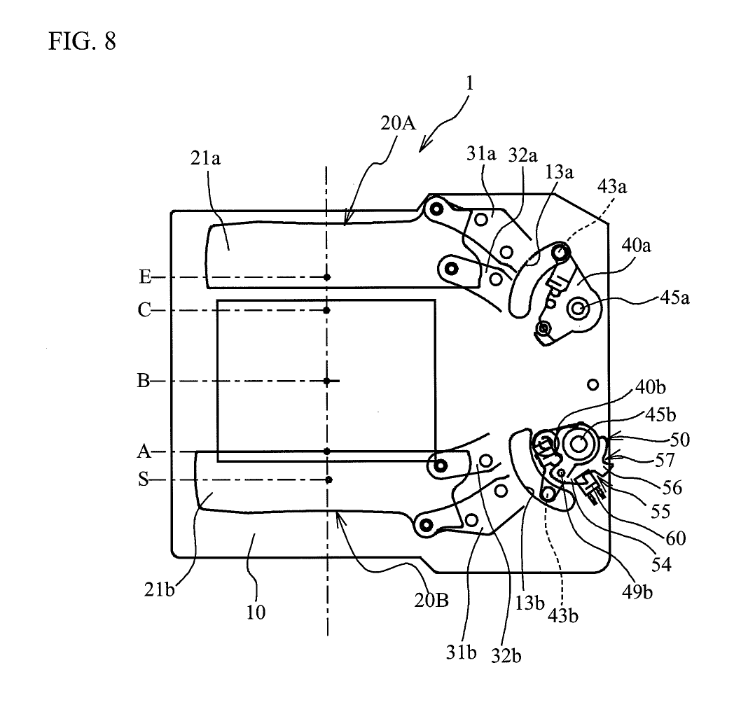

The energization of the trailing shutter coil 76b in the state illustrated in FIG. 7 rotates the trailing shutter drive lever 40b counterclockwise, and then the blade 21b moves to the opening 11. While the blade 21b is moving in the range SA from the start point S to the point A, the projection portion 54 of the thin plate 50 shades the light from the light emitting element 62. When the leading edge of the blade 21b arrives at the point A as illustrated in FIG. 8, the light receiving element 63 receives the light from the light emitting element 62 through the cutout portion 55 of the thin plate 50. Thus, in the exposure state as illustrated in FIG. 6, the signal of the sensor 60 is changed from the L signal to the H signal. Thus, the control portion 110 can detect that the trailing shutter 20B, specifically, the blade 21b has passed through the point A on the basis of a change in signal from the sensor 60.

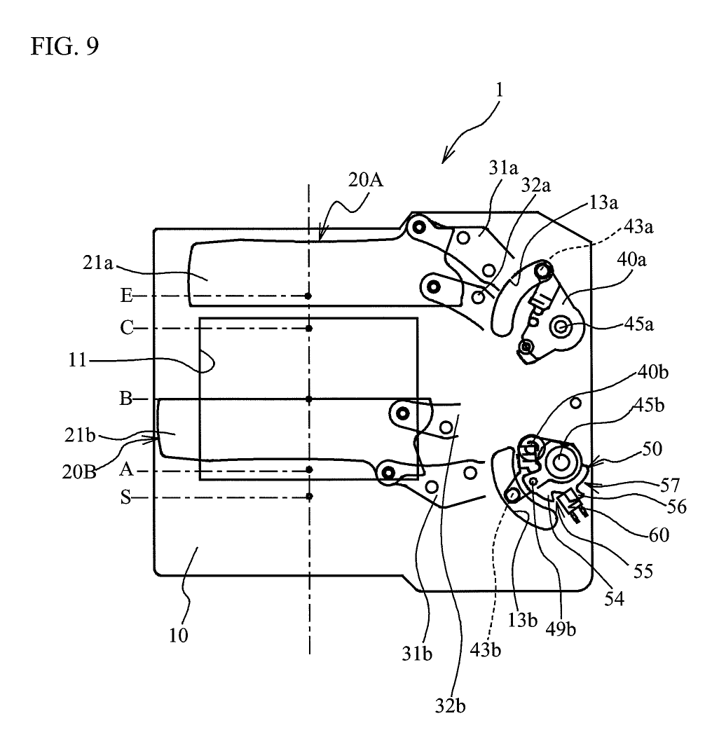

While the blade 21b is moving in the range AB from the point A to the point B, the light receiving element 63 receives the light from the light emitting element 62 through the cutout portion 55 of the thin plate 50. When the leading edge of the blade 21b arrives at the point B as illustrated in FIG. 9, the light from the light emitting element 62 is shaded by the projection portion 56 of the thin plate 50. Therefore, the signal of the sensor 60 is changed from the H signal to the L signal. Thus, the control portion 110 can detect that the blade 21b has passed through the point B on the basis of a change in signal from the sensor 60. Additionally, the point B is a middle point of the opening 11 in such a direction that the trailing shutter 20B moves, that is, the point B is a middle point between the points A and C. However, the point B is not limited to this point.

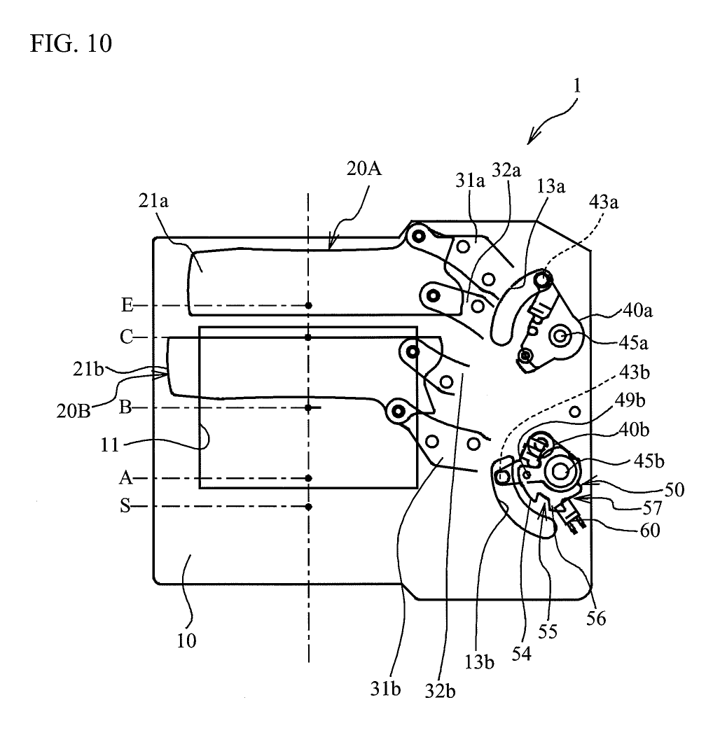

While the blade 21b is moving in the range BC from the point B to the point C, the light from the light emitting element 62 is shaded by the projection portion 56 of the thin plate 50. When the leading edge of the blade 21b arrives at the point C as illustrated in FIG. 10, the projection portion 56 recedes from the light from the light emitting element 62, and the light receiving element 63 receives the light from the light emitting element 62 through the cutout portion 57 of the thin plate 50. Therefore, the signal of the sensor 60 is changed from the L signal to the H signal. Thus, the control portion 110 can detect that the blade 21b has passed through the point C.

Moreover, while the trailing shutter drive lever 40b is rotating counterclockwise and the blade 21b is moving in the range CE, the light receiving element 63 receives the light from the light emitting element 62 through the cutout portion 57 of the thin plate 50. FIG. 11 illustrates the state where the blade 21b stops, that is, the exposure operation finished state. In this state, the trailing shutter 20B closes the opening 11. As mentioned above, the thin plate 50 and the sensor 60 can detect that the trailing shutter 20B has passed through the point A, B, and C.

In a state of the opening at the exposure state as illustrated in FIG. 6, a dashed line indicates an example of the trace of the movement of the electric trailing shutter in a simulated manner, since the control portion 110 resets the charge stored in the image pickup element 130 for every pixel line in the order from the lower side to the upper side, that is, from the point S to the point E. An exposure period AT indicates a period from when the reset operations start for resetting the stored charge of the pixel line, including the point A, of the image pickup element 130 in the electric leading shutter to when the leading edge of the blade 21b of the trailing shutter 20B arrives at the point A. That is, the exposure period AT indicates an opening lower portion exposure period. Likewise, an exposure period BT indicates a period from when the reset operations start for resetting the stored charge of the pixel line, including the point B, of the image pickup element 130 in the electric leading shutter to when the leading edge of the blade 21b of the trailing shutter 20B arrives at the point B. That is, the exposure period BT indicates an opening middle portion exposure period. Further, the exposure period CT indicates a period from when the reset operations start for resetting the stored charge of the pixel line, including the point C, of the image pickup element 130 in the electric leading shutter to when the leading edge of the blade 21b of the trailing shutter 20B arrives at the point C. That is, the exposure period BT indicates an opening upper portion exposure period.

Here, in an initial state of the camera A, a current value A1 applied to the trailing shutter coil 76b is set such that the exposure periods AT, BT, and CT are identical to one another. In other words, in the initial state of the camera A, the current value A1 is set such that exposure periods of the plural pixel lines within the opening are identical to each other. That is, since the trailing shutter 20B is driven by the current value A1 making the opening lower portion exposure period, the opening middle portion exposure period, and the opening upper portion exposure period identical to one another, photographing is ensured without the unevenness of exposure within the opening 11.

A moving period tAB indicates a period while the blade 21b is moving from the point A to the point B. The moving period tBC indicates a period while the blade 21b is moving from the point B to the point C. The control portion 110 can recognize the moving periods tAB and tBC on the basis of switching of the signal from the sensor 60. On the basis of switching of the signal from the sensor 60, the control portion 110 can recognize the period while the blade 21b is moving from the point A to the point C, that is, the moving period of the trailing shutter 20B.

Likewise, the control portion 110 is capable of recognizing, with a known counter means, a period from when the charges stored in the pixel line, including the point A, of the image pickup element 130 start being reset in the electronic leading shutter to when the charges stored in the pixel line, including the point C, of the image pickup element 130 start being reset, that is, the moving period of the electronic leading shutter.

Here, in the initial state of the camera A, the moving period of the trailing shutter 20B is identical to that of the electronic leading shutter. That is, in the initial state of the camera A, the current value A1 applied to the trailing shutter coil 76b drives the trailing shutter 20B such that the moving period of the electronic leading shutter is identical to that of the trailing shutter 20B. This ensures photographing without the unevenness of exposure within the opening 11.

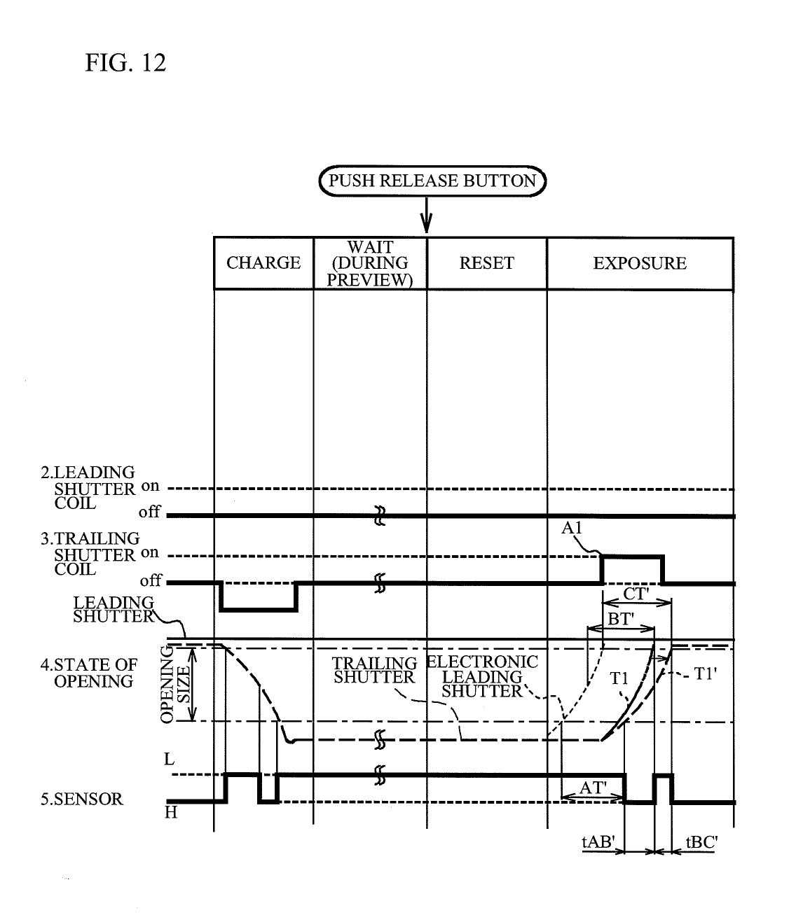

The rotational speed of the rotor 72b of the trailing shutter actuator 70b might be reduced by the aged deterioration. If the rotational speed of the rotor 72b is reduced, the moving speed of the trailing shutter 20B is reduced. FIG. 12 is a timing chart in a case where the moving speed of the trailing shutter 20B is reduced. T1′ indicates the movement of the trailing shutter 20B in the case where its moving speed is reduced. T1 indicates the movement of the trailing shutter 20B in the initial state before its moving speed is reduced. A moving period tAB′ indicates a period while the blade 21b is moving in the range AB in the case where the moving speed is reduced. A moving period tBC′ indicates a period while the blade 21b is moving in the range BC in the case where the moving speed is reduced. When the moving speed of the blade 21b is reduced, the moving periods tAB′ and tBC′ are longer than the moving periods tAB and tBC, respectively.

The exposure periods AT′, BT′, and CT′ in the case where the moving speed of the trailing shutter 20B is reduced, are longer than exposure periods AT, BT, and CT in the initial state before the speed is reduced, respectively. Also, the difference between the exposure periods BT′ and BT is greater than the difference between the exposure periods AT′ and AT. The difference between the exposure periods CT′ and CT is greater than the difference between the exposure periods BT′ and BT. That is, in the case where the moving speed of the trailing shutter 20B is reduced, a change in the opening middle portion exposure period is greater than a change in the opening lower portion exposure period, and a change in the opening upper portion exposure period is greater than a change in the opening middle portion exposure period. Thus, the difference between the exposure periods is greater as the pixel line is closer to the stop point E. In such a way, the difference between the exposure periods of the pixel lines might occur to make the unevenness of the image. The control portion 110 of the camera A according to the present embodiment changes the power to be supplied to the trailing shutter coil 76b on the basis of a reduction in the moving speed of the trailing shutter 20B. Specifically, the control portion 110 changes a current value applied to the trailing shutter coil 76b with a voltage being constant.

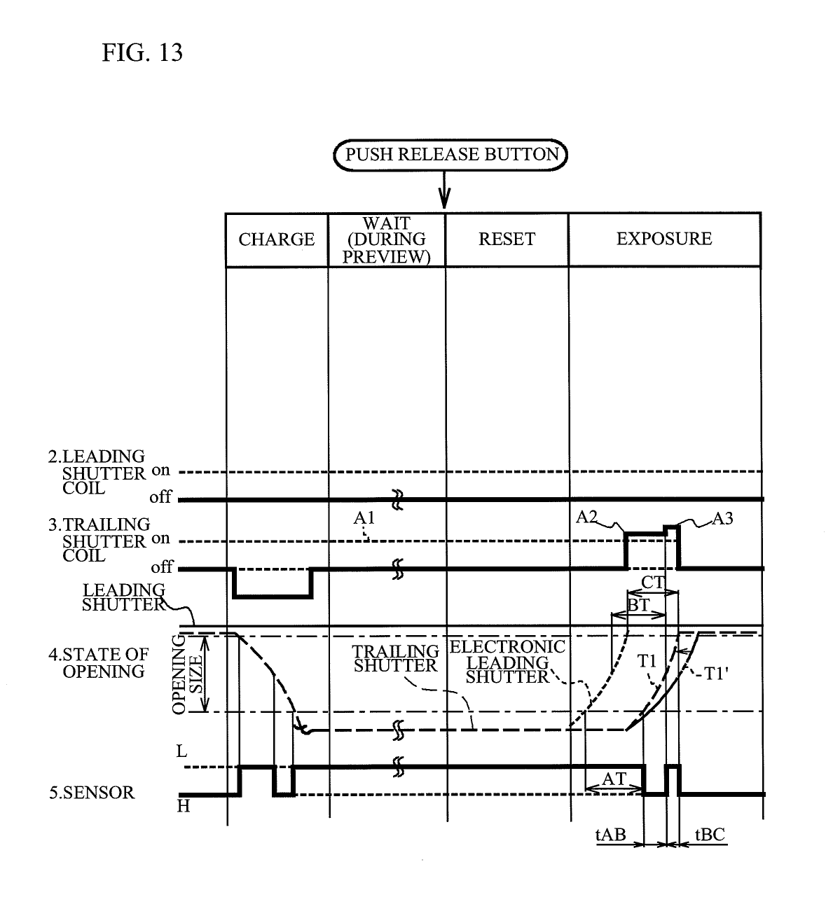

FIG. 13 is a timing chart when the electric current applied to the trailing shutter coil 76b is changed. The control portion 110 increases the current value applied to the trailing shutter coil 76b from the current value A1 to a current value A2, while the blade 21b is moving in the range SB. Also, the control portion 110 increases the current value applied to the trailing shutter coil 76b from the current value A2 to a current value A3, while the blade 21b is moving in the range BE. Thus, T1′ indicating the previous movement of the trailing shutter 20B can be returned to the movement T1 of the trailing shutter 20B in the initial state in this time. It is therefore possible to set the exposure periods AT, BT, and CT with the changed current value to be identical to one another, thereby suppressing a fluctuation in the exposure periods of the plural pixel lines within the opening defined by the electronic leading shutter and the trailing shutter 20B.

Additionally, the current value A3 is greater than the current value A2. The timing when the current value A3 is changed from the current value A2 is identical to the timing when the signal from the sensor 60 is changed from the H signal to the L signal after the trailing shutter 20B starts moving, but not limited to this. It is also preferable that all of the exposure periods AT, BT, and CT are identical to one another, after the current value is changed. However, at least two of them have only to be identical to each other.

In such a way, an increase in the current value applied to the trailing shutter coil 76b causes the trailing shutter 20B to move in the operating characteristics of the initial state, even if the moving speed of the trailing shutter 20B is reduced by the aged deterioration. It is thus possible to control the operating characteristics of the trailing shutter 20B to be identical to those of the electronic leading shutter. Specifically, the exposure periods AT, BT, and CT are identical to one another, and the moving period of the electronic leading shutter is identical to that of the trailing shutter 20B. Thus, this can suppress the difference between the exposure periods of the plural pixel lines within the opening defined by the electronic leading shutter and the trailing shutter 20B, thereby suppressing the unevenness of the image.

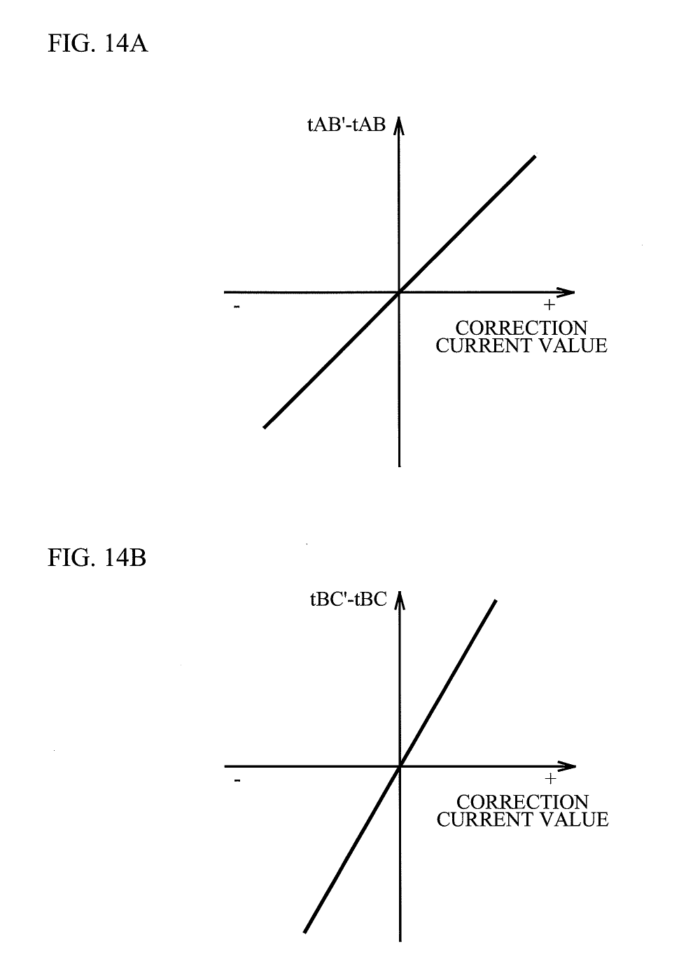

FIGS. 14A and 14B are maps for correcting a current value applied to the trailing shutter coil 76b. Such maps are stored beforehand in the ROM of the control portion 110. The vertical axis in FIG. 14A indicates a value given by subtracting the moving period tAB in the previous exposure operation from the moving period tAB′ in this exposure operation. The vertical axis in FIG. 14B indicates a value given by subtracting the moving period tBC in the previous exposure operation from the moving period tBC′ in this exposure operation. The horizontal axes in FIGS. 14A and 14B indicate correction current values for the current value A in the initial state. The value given by subtracting the moving period tAB from the moving period tAB′ means the difference between periods, caused by a change in the moving speed of the trailing shutter 20B, while the blade 21b is moving in the range AB. The value given by subtracting the moving period tBC from the moving period tBC′ means the difference between periods, caused by a change in the moving speed of the trailing shutter 20B, while the blade 21b is moving in the range BC.

The correction current value is added to the current value A1 in the initial state. The correction current value may take both plus and minus. The correction current value illustrated in FIG. 14A is added to the value A1 of the current applied to the trailing shutter coil 76b while the blade 21b is moving in the range SB. The correction current value illustrated in FIG. 14B is added to the value A1 of the current applied to the trailing shutter coil 76b while the blade 21b is moving in the range BE. In such a way, even when the moving speed of the trailing shutter 20B is reduced, the value of the current applied to the trailing shutter coil 76b is corrected based on the difference between the periods taken for the blade 21b to move in a predetermined range, whereby the moving speed of the trailing shutter 20B can be returned to the initial state at the next time of the exposure operation. Therefore, even when the moving speed of the trailing shutter 20B is reduced, the moving speed of the trailing shutter 20B can be retuned to the initial state at the next time of the exposure operation. This controls the operating characteristics of the trailing shutter 20B to be identical to that of the electronic leading shutter.

Additionally, although the value of the current applied to the trailing shutter coil 76b is constant, the moving speed of the trailing shutter 20B may be increased for some reason. The correction current value takes a minus value in such a case, and the minus value is added to the current value A1 in the initial state, so that the corrected current value is lower than the current value A1 in the initial state. Even when the moving speed of the trailing shutter 20B is increased, the moving speed of the trailing shutter 20B can be set identical to the moving speed in the initial state.

In the present embodiment, the timing when the current value is changed while the trailing shutter 20B is moving is identical to the timing when the blade 21b passes through the point B. However, the timing when the power is changed while the trailing shutter 20B is moving is not limited to the timing when the blade 21b passes through the point B. For example, the current value may be changed after a predetermined period is lapsed and the blade 21b passes through the point A or B.

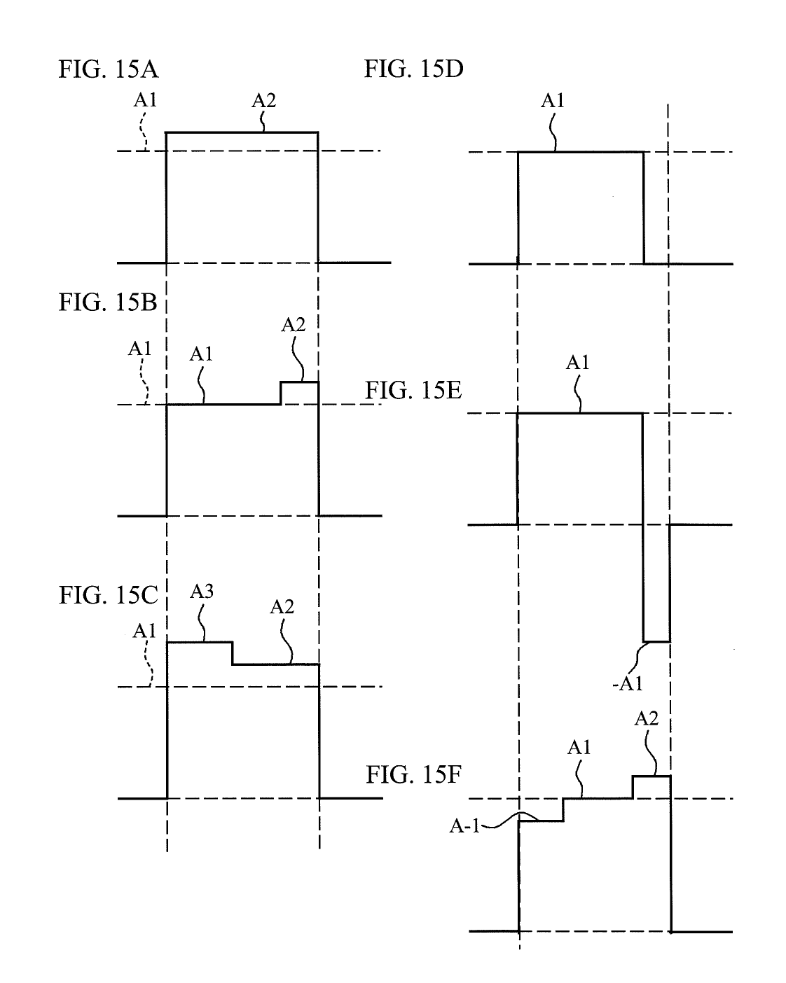

FIGS. 15A to 15F are explanatory views of variations of a current value applied to the trailing shutter coil 76b while the trailing shutter 20B is moving. As illustrated in FIG. 15A, a current value in all range where the trailing shutter 20B moves may be set to a current value A2 greater than the current value A1 in the initial state. For example, in a case where the camera A is used under a high temperature environment, an increase in the temperature of the trailing shutter coil 76b may increase its resistance and reduce the value of the current flowing through the trailing shutter coil 76b.

In this case, the current value is corrected to suppress a reduction in the moving speed of the trailing shutter 20B.

As illustrated in FIG. 15B, the current value A1 in the initial state may be changed to the current value A2, while the trailing shutter 20B is moving. As illustrated in FIG. 15C, a current value A3 may be changed to the current value A2 lower than the current value A3, while the trailing shutter 20B is moving.

As illustrated in FIG. 15D, the current applied to the trailing shutter coil 76b may be cut while the trailing shutter 20B is moving, thereby reducing the moving speed of the trailing shutter 20B. Therefore, the torque of the rotor 72b is weakened just before the moving trailing shutter 20B stops, thereby preventing the trailing shutter 20B from bounding at the time of stopping. Additionally, in this case, the current may be cut, for example, between the time when the blade 21b passes through the point B and the time when the blade 21b passes through the point C, or at the time when the blade 21b passes through the point C.

As illustrated in FIG. 15E, a reverse current (current value is A1) of the current value A1 may be applied while the trailing shutter 20B is moving. Therefore, the rotor 72b tends to rotate reversely just before stopping, thereby reducing the moving speed of the trailing shutter 20B just before stopping. This also suppresses the trailing shutter 20B from bounding.

As illustrated in FIG. 15F, a current value A-1 lower than the current value A1 may be changed to the current value A1 and A2 in this order, while the trailing shutter 20B is moving. In such a way, the current value may be changed twice or more, while the trailing shutter 20B is moving.

In the conventional image pickup device, an electronic leading shutter is controlled based on the operating characteristics of the mechanical trailing shutter so as to make the operating characteristics of the electronic leading shutter identical to those of the trailing shutter. However, such control might lead to a problem in that the moving speeds of the electronic leading shutter and the trailing shutter are changed depending on the aged deterioration or environment change. This might complicate the control for matching the operating characteristics of the electronic leading shutter identical with those of the trailing shutter, and might cause a variation in the exposure periods of plural pixel lines within the opening defined by the electronic leading shutter and the trailing shutter. There might be also another problem in that the image distortion, caused by a focal plane phenomenon at the time of taking a photo of an object moving at a high speed, is varied by the aged deterioration or environment change. In the image pickup device of the present embodiment, the operating characteristics of the mechanical trailing shutter is controlled based on the operating characteristics of the electronic lading shutter which are not basically changed, thereby suppressing a variation in the exposure periods of the plural pixel lines within the opening.

While the exemplary embodiments of the present invention have been illustrated in detail, the present invention is not limited to the above-mentioned embodiments, and other embodiments, variations and modifications may be made without departing from the scope of the present invention.

In the above embodiment, the value of the current applied to the trailing shutter coil 76b is changed, but a voltage value may be changed instead of the current value. This is because the power supplied to the trailing shutter coil 76b can be also changed.

The board 10 may be provided with a sensor including a light emitting element and a light receiving element facing each other. The trailing shutter 20B may pass between the light emitting element and the light receiving element, so that the sensor can detect that the trailing shutter 20B, for example, the blade 21b passes through a position where the sensor is provided. In this case, when the trailing shutter 20B recedes from this sensor, the light receiving element receives the light from the light emitting element. When the trailing shutter 20B passes through this sensor, the light from the light emitting element is shaded by the trailing shutter 20B, and then the light receiving element does not receive the light.

As described above, sensors may be provided for detecting that the leading shutter 20A and the trailing shutter 20B pass through given positions of their moving traces. In the above way, the exposure may be controlled by the leading shutter 20A and the trailing shutter 20B without using the electronic leading shutter.

The camera A may not be provided with the leading shutter 20A and the leading shutter actuator 70a.

The control portion 110 and the drive control portion 170 may be achieved by a single IC tip.

In the above embodiment, the blade is made of a synthetic resin, but the blade may be made of metal having a thin shape.

In above embodiment, each of the leading shutter and the trailing shutter is composed of four blades, but not limited to this.

Each of the leading shutter and the trailing shutter may be composed of two or more blades.

As for the sensor 60, the thin plate 50 shades the light going to the light receiving element 63 from the light emitting element 62 so as to detect the position of the trailing shutter drive lever 40b, but not limited to such a configuration. For example, in order to shade the light going from the light receiving element to the light emitting element by the trailing shutter drive lever 40b in accordance with the movement of the trailing shutter 20B, a projection is provided in the trailing shutter drive lever 40b.

In above embodiment, the power applied to the trailing shutter coil 76b is controlled so as to make the exposure periods of the plural pixel lines within the opening identical to each other, and in addition, make the moving periods of the electronic leading shutter and the trailing shutter 20B identical to each other. However, only the exposure periods of the plural pixel lines within the opening may be made identical to each other, and the moving periods of the electronic leading shutter and the trailing shutter 20B may not be made identical to each other.

Also, in the above embodiment, only the moving periods of the electronic leading shutter and the trailing shutter 20B may be made identical to each other. In other words, the control portion 110 may control the power applied to the actuator driving the trailing shutter so as to make the moving periods of the electronic leading shutter and the trailing shutter 20B identical to each other. This suppresses the unevenness of the image by moving the trailing shutter 20B with the operating characteristics same as the those in the initial state, even when the moving speed of the trailing shutter 20B is reduced by the aged deterioration.

What is claimed is:

1. An image pickup device comprising:
an image pickup element;
a control portion sequentially resetting charge stored in the image pickup element for every pixel line in a predetermined direction such that an electronic leading shutter moves in a simulated manner;
a focal plane shutter including:
a board including an opening;
a mechanical type of a trailing shutter capable of opening and closing the opening;
an actuator driving the trailing shutter; and
a detection portion detecting that the trailing shutter passes through a given position of a movement trace of the trailing shutter; and
a drive control portion controlling driving of the actuator based on a detection result of the detection portion.

2. The image pickup device of claim 1, wherein the drive control portion changes power supplied to the actuator to make exposure periods of at least two pixel lines identical to each other.

3. The image pickup device of claim 1, wherein the drive control portion changes the power supplied to the actuator to make moving periods of the electronic leading shutter and the trailing shutter identical to each other.

4. The image pickup device of claim 1, wherein the drive control portion changes the power supplied to the actuator while the trailing shutter is moving.

5. The image pickup device of claim 1, wherein the drive control portion stops supplying the power to the actuator while the trailing shutter is moving.

6. The image pickup device of claim 1, wherein the drive control portion reverses a direction in which power is supplied to the actuator while the trailing shutter is moving.

7. The image pickup device of claim 1, wherein the given position includes at least two positions.
